(19) United States
(12) Patent Application Publication
(10) Pub. No.: US 2013/0061569 A1
(43) Pub. Date: Mar. 14, 2013

(54) Device for flattening corn stalk stubbles

(71) Applicant: Dean J. McClenathen, Jasper, MI (US)

(72) Inventor: Dean J. McClenathen, Jasper, MI (US)

(21) Appl. No.: 13/373,036

(22) Filed: Nov. 2, 2011

Related U.S. Application Data
(60) Provisional application No. 61/456,292, filed on Nov. 3, 2010.

(51) Int. Cl. A01D 45/02; F16M 13/02

(52) U.S. Cl. 56/52; 248/231.9

(57) ABSTRACT

The present invention is directed to a new and simplified device for controlling residual agricultural products. In particular, the device is useful for folding over corn stalk stubble or other stubble which may be protruding from the surface of the earth. The end of the flattening shoe which contacts the corn stubble is provided with an angled or radius section which insures that the flattening shoe will not dig into the earth as it is advanced by the vehicle and, if the device should become unattached, it will not damage tires that are immediately following.

### CROSS REFERENCE TO RELATED APPLICATIONS

This application claims the benefit of U.S. provisional patent application No. 61/456,292 and filed on Nov. 3, 2010.

### BACKGROUND OF THE INVENTION

Following and during the harvesting of corn and cutting of the corn stalks, a stubble remains attached to the soil and will frequently extend 4 to 6 inches above the surface of the earth. The presence of stubble extending upwardly from the earth has been a significant problem for the tires of tractors and combines passing there over in that it can damage the tires or reduce the serviceable life of the tractor tires. This is especially true of some newer varieties of corn which produce larger yields but also have stalks which are stiffer than a typical corn stalk of, say, ten years ago or earlier. Additionally, as pointed out in U.S. Pat. No. 6,648,078 corn stalk stubble cures in the field all winter thereby resulting in an extremely stiff stalk by the time of spring planting. The aforesaid U.S. Pat. No. 6,648,078 discloses one type of apparatus for folding over corn stalk stubble. Another prior art device for folding over stubble is one sold under the name Stalk Stomper, by May Wes Manufacturing, Hutchinson, Minn.

### SUMMARY OF THE INVENTION

The present invention is directed to a new and simplified device for controlling residual agricultural products. In particular, the device is useful for folding over corn stalk stubble or other stubble which may be protruding from the surface of the earth. In contrast to the prior art which discloses apparatus having a large number of components and/or complex features, the device of the present invention has significantly fewer components than prior art apparatus for folding over agricultural products such as corn stalk stubble. Some prior art apparatus includes a complex arrangement of supporting members and chains while others include pivotally mounted stomping shoes with compression springs for urging the shoes downwardly to maintain pressure on the stubble. In contrast, the device of the present invention does not require a separate coil spring for urging the flattening shoe against the corn stalk stubble. Additionally, the end of the flattening shoe which contacts the corn stubble is provided with an angled or radius section which insures that the flattening shoe will not dig into the earth as it is advanced by the vehicle and, if the device should become unattached, it will not damage tires that are immediately following.

The present invention has three basic components, namely a shoe for contacting and bending over the stubble, a connecting spring strap engaged to the tractor or combine and a mounting bracket to connect the flat spring to the vehicle. The spring strap, in addition, to provide support for the flattening shoe, is designed to urge the shoe downwardly to maintain pressure on the stubble being bent over.

### IN THE DRAWINGS

FIG. 1 is an elevational view looking in the direction as viewed with the tractor and the flattening shoe approaching toward the viewer.

FIG. 2 is a side view showing the device of the present invention in position to be attached to the frame of a tractor.

FIG. 3 is a sectional view taken through line 3-3 of FIG. 1.

FIG. 4 is a side elevational view of an additional feature of the invention.

FIG. 5 is a side elevational view of an additional feature of the invention.

FIG. 6 is a side elevational view of a mounting bracket that can be used with the device.

FIG. 7 is a side elevational view of the opposite side of the bracket of FIG. 6.

FIG. 8 is a side elevational view of a mounting bracket that can be used with the device.

FIG. 9 is a side elevational view of a mounting bracket that can be used with the device.

FIG. 10 is a top view of the bracket shown in FIG. 9.

FIG. 11 is a perspective view of the bracket of FIG. 6 shown mounted on a vehicle.

FIG. 12 is a top view of a mounting bracket that can be used with the device.

FIG. 13 is a side elevational view of the bracket of FIG. 12.

FIG. 14 is a side elevation view of a mounting bracket that can be used with the device of the present invention.

FIG. 15 is a front elevation view of the mounting bracket of FIG. 14.

FIG. 16 is a partial top view of the mounting bracket of FIG. 14.

### DETAILED DESCRIPTION OF THE INVENTION

The present invention is directed to a device for controlling residual agricultural products. In particular, the device is useful for flattening corn stalks and other agricultural products that are present in a form field after the crop has been harvested. Such residual agricultural products are very strong, especially if left in place over the winter, and can cause damage to farm equipment and the tires associated with such farm equipment. The device of the present invention can be used to flatten the residual agricultural products during the harvesting of the crop or, if the stalks are left in the field, while preparing the field for planting. The features of the invention will be more fully understood by reference to the attached drawings in connection with the following description.

Referring to the drawings, the device 1 of the present invention includes a flattening shoe 10 and a steel spring strap 20 engaged to and supporting the shoe 10. As shown in FIG. 2, the end of the spring strap 20 spaced from the shoe 10 may be bolted or otherwise fastened to a head or other structural member 40 of a vehicle such as a combine or tractor. Such structural member 40 may be raised and lowered. The spring strap can also be attached to a pivot bracket that allows the shoe to be pivoted to different locations with respect to the vehicle when the shoe is not being utilized to engage agricultural products.

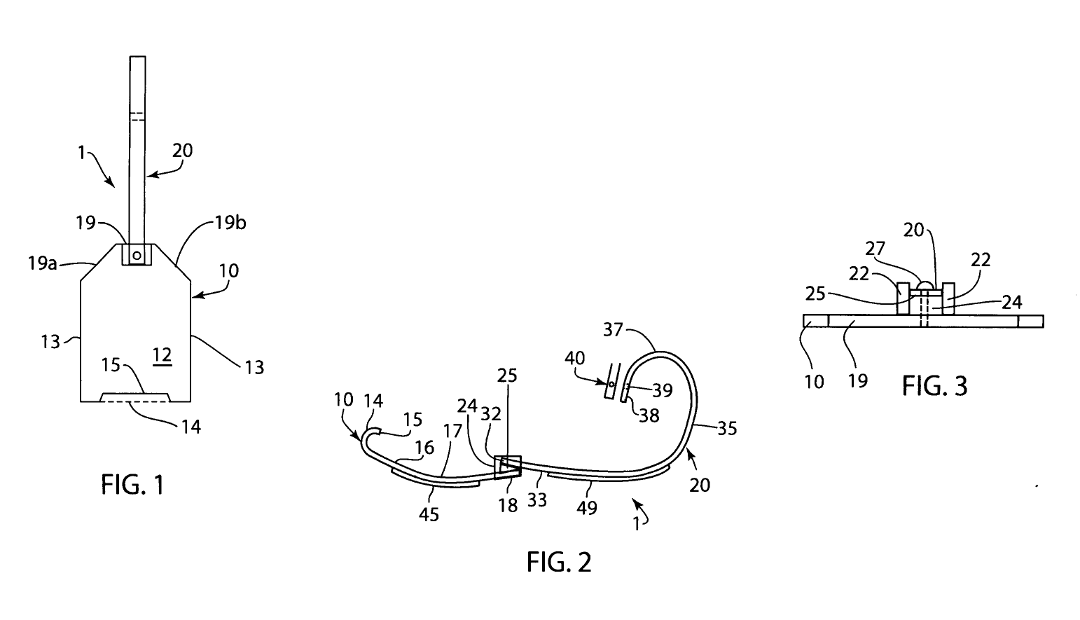

The shoe includes a body section 12 having a pair of parallel spaced apart edges 13 extending to a curled toe 14. As can be seen in FIG. 1, the curled toe 14 extends to an end 15. As the shoe extends from the body section 12 to form curved leading end or toe 14 towards the end 15, it narrows down so that the width of the end 15 is significantly shorter than the distance between the edges 13 on the body section 12. This may be seen in FIG. 1.

As may be seen in FIG. 2, the shoe 10 has a generally flat portion 16 extending toward the spring strap 20 and in a direction toward the tractor. The flat portion 16, which is intended to contact the ground, is followed by a short arcuate section 17 and finally by a flat section 18 forming the engagement end with the spring strap 20 which is engaged to the vehicle, such as a tractor or combine. For example, the flat section 16 could be on the order of from about 2 to about 8 in length, the curve section 17 could be on the order of from about 1½ to about 4 inches in length and the flat engagement end section could be on the order of from about 3 to about 8 inches in length. As can be seen in FIG. 1 the flat engagement section 18 extends to an end edge 19 which has a length on the order of from about 2 to about 3 inches. Edge portions 19A and 19B, each disposed at an angle of approximately 45 degrees from the respective edges 13, join the end edge 19 with the respective side edges 13. The flat portion 16 and arcuate section 17 are disposed for engaging the residual agricultural products, such as corn stalk stubble. The shoe 10 is usually formed of steel having a thickness from about ⅛ of an inch to about ¾ of an inch.

Welded or otherwise attached to the surface of the shoe 10 opposite the surface intended to contact the ground are a pair of spaced apart support members 22. The space between the support members 22 is such as to snuggly receive therebetween the spring strap 20. As may be seen in FIGS. 2 and 3 a wedge member 24 having a face 25 disposed at an angle in the range of from about 20° to about 30° is positioned between the support members 22 and rests on the surface of the flat section 18. The wedge increases in thickness as it moves away from such end 19. The wedge 24, the shoe 10 and the spring strap each have a hole for receiving a bolt 27 for connecting the shoe 10 to the spring strap 20.

It will be appreciated that the flat portion 16 and the arcuate section 17 of the shoe are intended to engage and bend over the stalk stubble. The curled end 14, by virtue of its curved orientation, will not dig into the ground as it is moved along by the vehicle or when the tractor or combine is placed in reverse motion. In addition, the curved shape of the leading edge 14 will prevent this portion of the shoe 10 from damaging the tires of the vehicle if the device is displaced from the vehicle. The curved shape of the leading edge 14 also allows the device 10 to bend over stalk stubble if the vehicle is moving in the opposite or reverse direction.

FIG. 2 shows an edge view of the spring strap 20 and its various sections. The strap is preferably on the order of from about ⅛ to about ½ inch in thickness and has a preferred width of from about 1 to about 4. The spring strap is preferably made from spring steel. The design of the strap 20 with its curves is such as to provide a spring action to hold the shoe snuggly but resiliently against the surface of the ground as the shoe is being moved there along to fold over the stubble. As such the strap 20 extends from a connection end 32 followed by a generally straight section 33 having a length on the order of 9 inches plus or minus 1 inch. The straight section 33 merges to an enlarged curved section 35 having a radius on the order of 12 inches, plus or minus 1 inch, followed by a smaller curved section 37 disposed at a radius of 3 inches, plus or minus ½ inch. The smaller curved section 37 leads to a flat vehicle connecting end portion 38. The connecting end portion 38 is provided with an aperture 39 for receiving bolts for fastening the connecting end portion 38 to a structural member 40 of a vehicle such as a tractor or combine.

A device 1 of the present invention is easily attached to a vehicle such as a tractor or combine as it weighs only about 35 pounds and can be readily handled by a single person. The device is usually positioned on the front of the vehicle and bends over the stalk stubble before the vehicle encounters the stubble. The device can, however, also be positioned to engage and bend over the stalk stubble after the vehicle has moved over the stubble. Additionally, because of the fact that so few parts are needed for the device of the present invention compared to the prior art, it is much less expensive than other devices for flattening residual agricultural products such as corn stalk stubble.

A protective layer 45 can be positioned on the flat portion 16 and the arcuate section 17 of the shoe. A protective layer 49 can also be positioned on the straight section 33 of the spring strap 20. The protective layers 45, 49 can be made of a material that protects the shoe and spring strap from abrasion from the residual agricultural products. The protective layer 45, 49 can also be made of a material that assists in having the shoe and spring strap slide over the residual agricultural products. An example of a material that works particularly well for the protective layer is ultra high molecular weight plastic such as polyethylene and nylon.

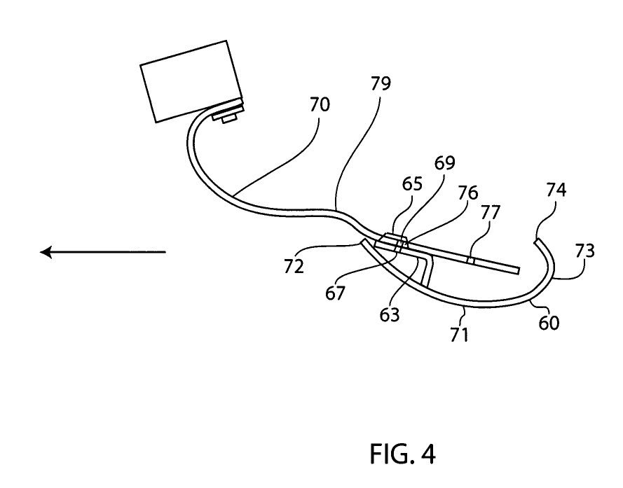

FIG. 4 shows additional features that can be used with the device of the present invention. As shown in FIG. 4, the shoe 60 is essentially the same as the shoe 10 previously described. The shoe 60 varies in that the shoe has a curved section 71 with a substantially constant radius of curvature from the end 72 where the shoe is secured to the spring strap to the beginning of the curled toe 73 adjacent the end 74. The constant radius curved section 71 has a radius of 9 to 15 inches, and a length from about 6 to about 15 inches. The total length of the shoe is from about 15 to about 30 inches and the width is from about 6 to about 15 inches. The preferred length of the shoe is from about 18 to 22 inches and the preferred width is from about 9 to about 12 inches. Also an L-shaped bracket 63 is welded or secured to the shoe. The L-shaped bracket is used to mount a spring strap 70 to the shoe. A flange 65 is positioned on each side of the L-shaped bracket 63 to snuggly receive the spring strap. A hole 67 is provided in the L-shaped bracket to receive a bolt 69 for securing the spring strap 70 to the shoe 60. The spring strap 70 is similar to the previously described spring strap 20. The spring strap 70 has a first hole 76 and a second hole 77 for mounting the spring strap to the shoe 60 in the manner previously described. The holes 76 and 77 disposed between the end 72 of the spring strap and the curved section 71. The first hole 76 provides a mounting point for the spring strap 70 that applies the most biasing force on the shoe 60 in a direction towards the residual agricultural products. The second hole 77 is closer to the end 72 and proves less biasing force on the shoe 60. Additional holes can be provided on the spring strap if it is desired to provide more adjustability for the biasing force that the spring strap provided to the shoe. The first and second holes 76 and 77 are positioned in the spring strap so that a portion of the spring strap extends over the shoe 60.

FIG. 4 shows another feature that can be used with the stalk bending device. The spring strap 70 has a second curved section 79 that is positioned between the curved section 71 and the first hole 76. The second curved section provides additional spring force that assists in biasing the shoe 60 in a direction towards the residual agricultural products.

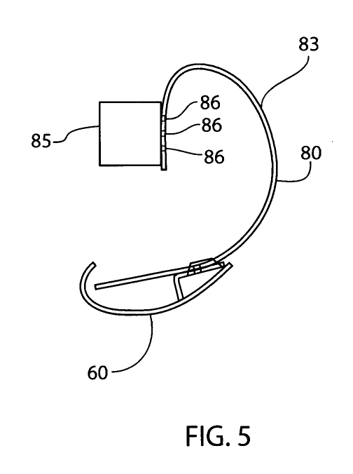

FIG. 5 shows additional features that can be used with the device of the present invention. The device shown in this figure is essentially the same as the device shown in FIG. 4. The mounting of the spring strap 80 to the vehicle 85 has been modified. The mounting location 87 on the vehicle 85 has been moved to a vertical orientation which results in a greater curvature for the curved section 83. The increased curvature for the spring strap 80 increases the biasing force that the spring strap places on the shoe 60. In addition, one or more holes 86 can be provided on the spring strap to secure the spring strap to the vehicle 85. If multiple holes 86 are provided in the spring stop the position of the spring strap with respect to the vehicle can be adjusted.

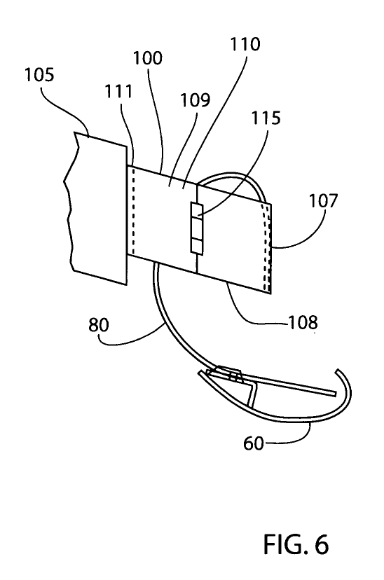

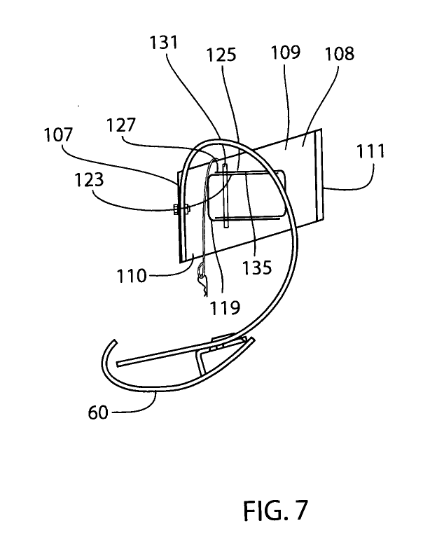

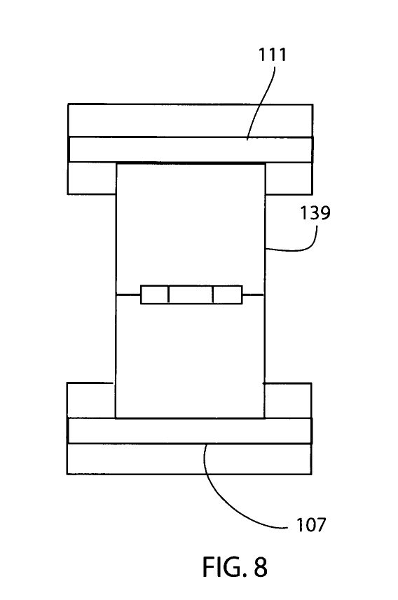

FIGS. 6, 7 and 8 show additional features that can be used with the device of the present invention. As show in FIG. 6 pivot bracket 100 is mounted on the vehicle 105. The pivot bracket has a mounting surface 107 for securing the spring strap 20, 70, 80 to the vehicle. The pivot bracket has a side wall 109 that extends from the mounting surface in a direction toward the vehicle 105. The sidewall 109 has a first section 108 and a second section 110. A mounting flange 111 is positioned on the end of the sidewall 109 that is spaced apart from the mounting surface 107 for the spring strap. The mounting flange is used to removably secure the pivot bracket 100 to the vehicle 105. A hinge 115 is positioned on the sidewall 109 between the first section 108 and the second section 110. The hinge allows the sidewall to pivot to move the device in a direction that allows for more clearance with regard to the vehicle. As shown in FIGS. 6 and 7 the hinge is located in a generally vertical orientation and in FIG. 8 in a generally horizontal location. The orientation of the hinge 115 dictates the direction that the device can be moved to provide additional clearance with the vehicle. A locking means 119 can be operatively connected to the sidewall 109 to secure the sidewall in the desired location with respect to the vehicle. The locking device 119 has at least a first member 123 that is connected to the first section 108 and a second member 125 positioned on the second section 110 of the sidewall 109. A hole 127 is positioned in each of the first and second members and a pin 131 is positioned in the holes 127 to secure the sidewall in a straight orientation. To change the position of the device, the pin 131 is removed and the hinge 115 can be used to change the location of the shoe and spring strap. A second hole 135 is positioned in the first member 123 and when the pivot bracket is moved the pin 131 can be positioned in the second hole 135 in the first member and hole 127 in the second member to hold the pivot bracket in the new pivoted location. As shown in the drawings more than one first 123 and second 125 members can be positioned on the sidewall 109 to provide additional strength for the locking mechanism. The pin 131 can extend through all of the first and second member. As shown in FIG. 8 the orientation of the sidewall 139 is changed to allow the shoe and spring strap to pivot in a different direction. As shown in FIG. 7, the pivot bracket allows the shoe and spring strap to pivot in a generally sideways direction and in FIG. 8 the shoe and spring strap move in a generally vertical direction. The locking device for the device of FIG. 8 functions in the same manner as the locking device shown in FIG. 7 with the understanding that the orientation of the locking device has been rotated. When the hinge has been utilized, the device is usually no longer in an orientation where it can contact the residual agricultural products.

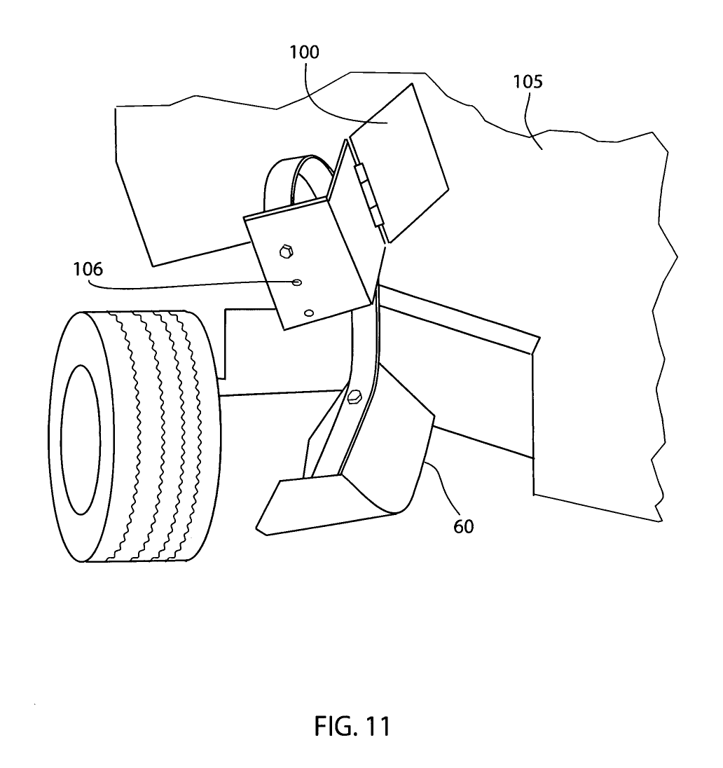

FIG. 11 shows one example where the pivot bracket 100 has been rotated to provide a different location for the device with respect to the vehicle 105. Also in this figure the mounting surface 107 can have more than one hole 106 for securing the spring strap 80 to the pivot bracket 100. This allows for additional adjustment for the position of the shoe 60 with respect to the vehicle and the ground.

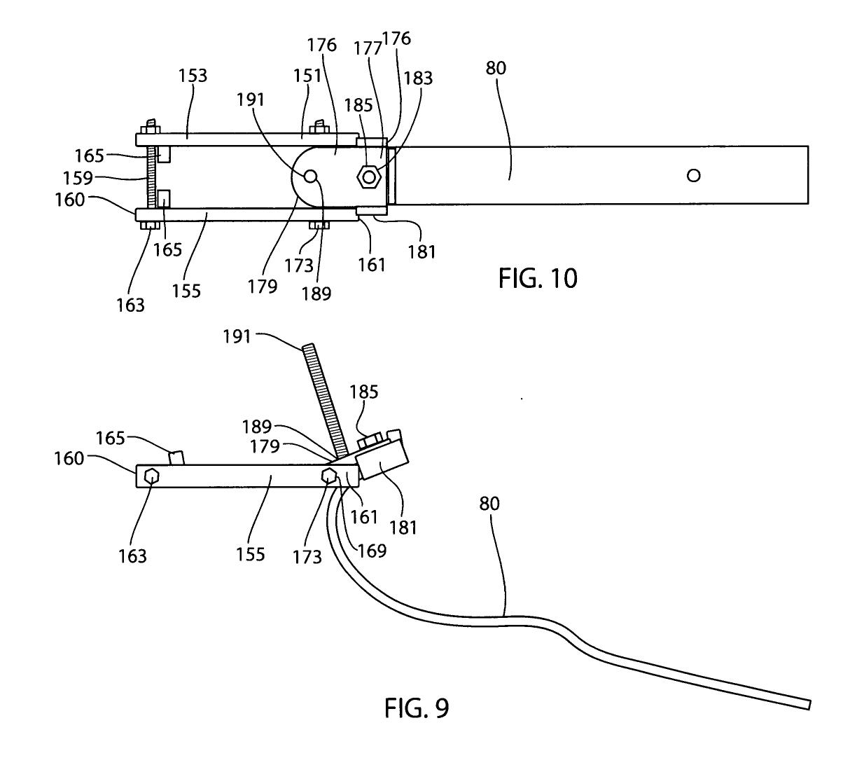

FIGS. 9 and 10 show another feature that can be used with the device of the present invention. As shown in these Figures a different mounting bracket 151 is used to secure the spring strap 80 to the vehicle. The mounting bracket has a first support member 153 and a second support member 155 that are positioned in substantially parallel spaced apart relationship. An aperture 159 is positioned in the first end 160 of each of the first and second support members. A bolt 163 can be positioned in the apertures 159 to secure the mounting bracket to the vehicle. A tab 165 is positioned on each of the first and second support members adjacent the aperture 159. The tabs are disposed to engage the vehicle and hold the first and second support members in the desired location with respect to the vehicle.

The second end 161 of the first and second support members also has an aperture 169. A pivoting securing bracket 171 is pivotably secured to the first and second support members by a bolt 173 that extends between the apertures 169 in the first and second support members. The securing bracket has a plate 176 and a passageway 175 is defined in the plate. A bolt 173 extends through the passageway to pivotably secure the securing bracket to the first and second support members. The plate 176 has a first end 177 and a second end 179. A flange 181 is positioned on each side of the first end of the plate and the flanges are disposed to securely engage the sides of the spring strap 80. A hole 183 is positioned in the plate to be in alignment with the hole in the end of the spring strap 80. A bolt 185 is positioned in the hole in the plate and the hole in the spring strap to secure the spring strap to the plate. The flanges 181 assist in locating the spring strap with respect to the plate.

A threaded aperture 189 is positioned on the second end of the plate 176. A threaded bolt 191 is rotatably positioned in the threaded aperture. The threaded bolt is disposed for engaging a surface on the vehicle whereby the bolt can be rotated to adjust the position of the plate with respect to the vehicle. The adjustment for the plate 176 allows the position of the spring strap 80 and shoe 60 that attached to the plate, to be adjusted with respect to the vehicle.

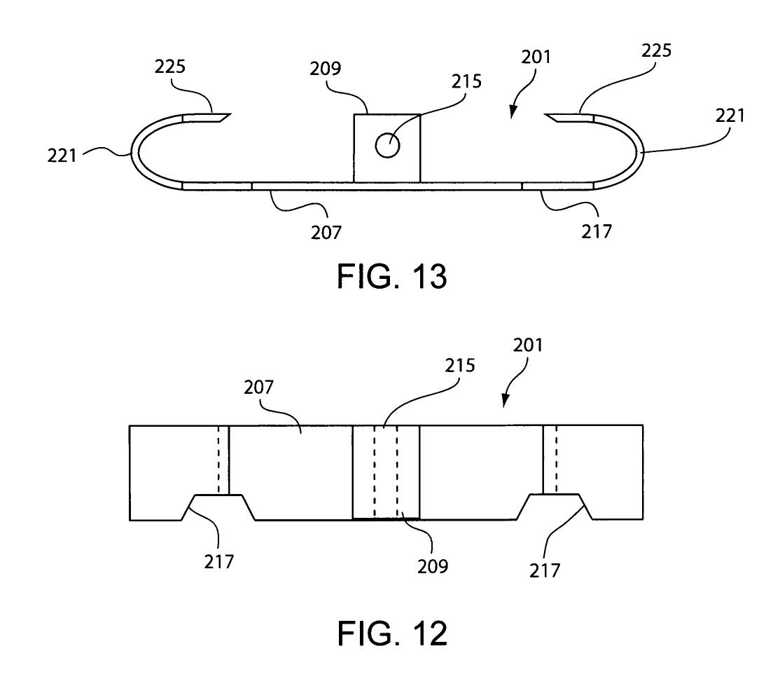

FIGS. 12 and 13 show another feature that can be used with the device of the present invention. As shown in the figures a different support bracket 201 is used to secure the spring strap to the vehicle. The support bracket has a base 207 with a block 209 positioned on the center of the base. A threaded aperture 215 is disposed in the block 209 and is positioned substantially parallel with the base. A notch 217 is positioned in the base on each side of the block 209. A curved section 221 is located on each end of the base 207. The ends 225 of each curved section are disposed to be substantially parallel with the base and extending in a direction towards the block 209. A threaded bolt extends from a vehicle to engage the threaded aperture 215 in the block 209. The threaded bolt secures the support bracket to the vehicle.

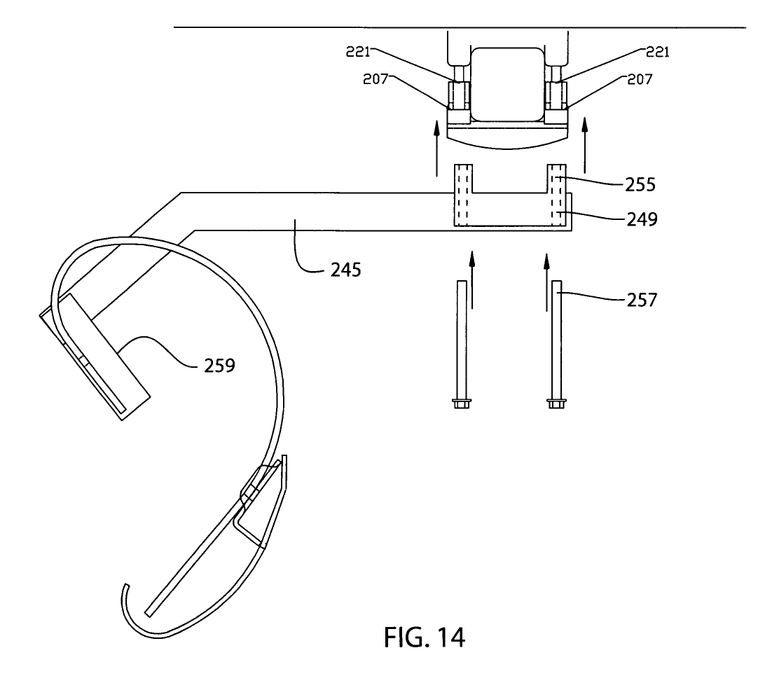

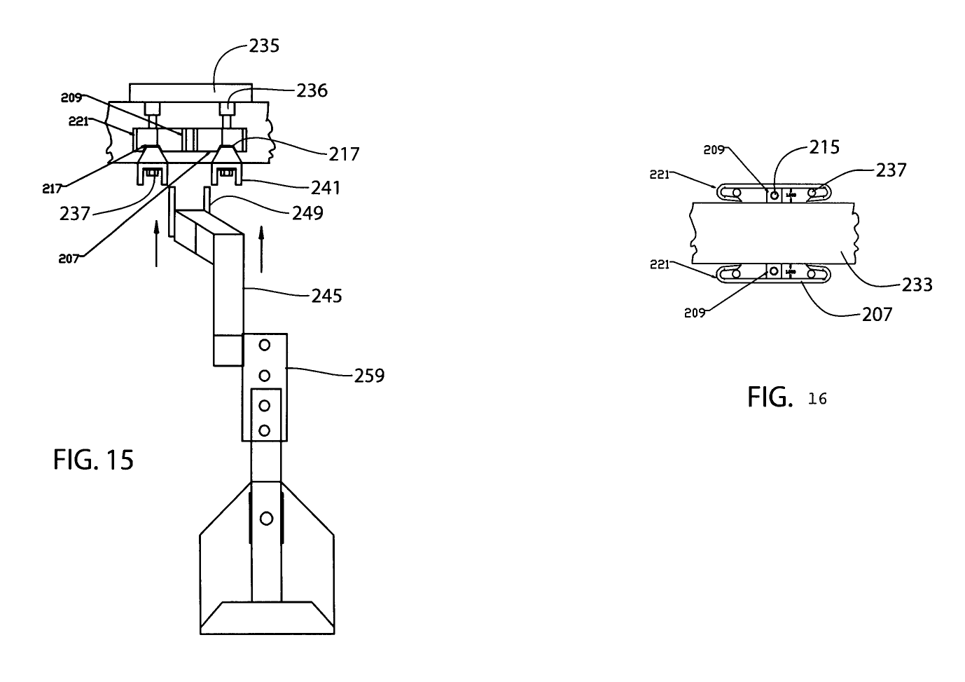

As shown in FIGS. 14, 15 and 16 the support brackets 201 are positioned on each side of a frame member 233 of a vehicle 236. The support brackets are held in place by bolts 237 that extend into threaded apertures 236 on the vehicle. Shackles 241 are positioned on the bolts 237 and the shackles engage the notches 217 on the base 207 on each side of the block 209. The shackles, by engaging the notches, prevent the support bracket from moving with respect to the bolts 237 and the vehicle 235.

An extension arm 245 having a mounting yoke 249 is secured to the support brackets 201. The yoke 249 has two passageways 255 that are disposed to be in alignment with the threaded apertures 215 in the block 209 of the support bracket. Bolts 257 are positioned to extend through the passageways 255 and to threadingly engage the threaded apertures 215 in the support brackets. The bolts 257 effectively secure the extension arm 245 to the support brackets and therefore to the vehicle 235. A mounting flange 259 is secured to the end of the extension arm 245 that is spaced apart from the yoke 249. The mounting flange is disposed to mount the stalk crusher device 1 to the vehicle in a manner previously described.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense.

I claim:

1. A device attached to a vehicle for controlling residual agricultural products comprising:
a skid plate having a first side for engaging the residual agricultural products, the skid plate having a second side that is disposed opposite the first side;
a mounting bracket positioned on the second side of the skid plate;
a spring strap that has a first end attached to the vehicle and a second end attached to the mounting bracket on the skid plate, the spring strap being disposed to resiliently bias the skid plate in a direction towards the residual agricultural product.

2. The device of claim 1 wherein the first end of the spring strap has a curved section that provides additional biasing force for the skid plate in the direction towards the residual agricultural product.

3. The device of claim 1 wherein the second end of the spring strap has at least two apertures for securing the flat spring to the mounting bracket.

4. The device of claim 3 where the at least two apertures are spaced apart and provide different levels of biasing force for the skid plat when attaching the skid plate to the spring strap.

5. The device of claim 4 wherein the second end has an end portion that is beyond the at least two apertures, the end portion is disposed to extend over the skid plate.

6. The device of claim 1 wherein the spring strap has a center portion that is spaced between the first and second ends, the center portion has a curved profile, the curved profile increasing the biasing force that the flat spring places on the skid plate.

7. The device of claim 1 wherein the mounting bracket has an opening that is placed in alignment with at least one aperture on the flat spring, a bolt positioned in the opening and at least one aperture to secure the spring strap to the skid plate.

8. The device of claim 7 wherein an L shaped bracket is secured to the second side of the skid plate and positions the mounting bracket in spaced apart relationship with the second side of the skid plate.

9. The device of claim 7 wherein a flange is disposed on each side of the opening, the flanges are positioned to center the spring strap on the mounting bracket and the skid plate.

10. The device of claim 7 wherein a wedge shaped member is positioned on the mounting bracket, the wedge shaped member being disposed to place the flat spring at an angle with respect to the skid plate to increase the biasing force provided by the flat spring to the skid plate.

11. The device of claim 1 wherein the skid plate has a first end, a center section and a second end, the mounting bracket being positioned adjacent the first end.

12. The device of claim 11 wherein the center section is flat and is disposed to contact the ground where the residual agricultural products are located, the first ends disposed at an angle with respect to the center section and ending adjacent the flat spring, the second end being curved and extending in a direction above the flat spring.

13. The device of claim 1 wherein a pivot bracket is positioned on the vehicle and the first end of the spring strap is secured to the pivot bracket.

14. The device of claim 13 wherein the pivot bracket is designed to pivot in a vertical or horizontal manner whereby the device can be positioned with regard to the vehicle to accommodate various uses.

15. The device of claim 14 wherein the pivot bracket has a locking mechanism to lock the skid plate in a position for contacting the residual agricultural products or to lock the skid plate in a position where it does not contact the residual agricultural products.

16. The device of claim 1 wherein an ultra high molecular weight plastic is positioned on the side of the skid plate that engages the residual agricultural products.

17. The device of claim 16 wherein a ultra high molecular weight plastic is positioned on the side of the spring strap that faces the residual agricultural products.

18. The device of claim 17 wherein the ultra high molecular weight plastic is selected from the group of polyester, polypropylene and nylon.

19. A mounting bracket to secure stalk flattening device to a vehicle comprising:
a first and a second support members positioned in substantially parallel spaced apart relationship, the first and second support members having a first end and a second end;
an aperture positioned in the first end of the first and second support members;
a bolt positioned in the aperture to secure the first and second support member to the vehicle;
a tab positioned on each of the first and second support members adjacent the apertures, the tabs being disposed to engage the vehicle to position the first and second support members in the desired location with respect to the vehicle;
a pivot bracket moveably positioned on the second end of the first and second support members;
a hole in the pivot bracket for attaching a spring strap of a stalk crusher;
a threaded aperture positioned in the pivot bracket;
a threaded rod disposed in the threaded aperture, the threaded rod being positioned to engage the vehicle and to adjust the position of the stalk crusher with respect to the vehicle.

20. A bracket for securing a stalk crushing device to a vehicle comprising:
a support bracket having a base and a block positioned in the center of the base;
a threaded aperture disposed in the block;
a threaded bolt extending from the vehicle for engaging the threaded aperture to secure the support bracket to the vehicle;
a curved section on each end of the support bracket, the curved sections being disposed to engage a mounting fixture, the mounting fixture being disposed to secure the stalk crusher device to the vehicle.

21. The bracket of claim 20 wherein at least two support brackets are used to secure the stalk crusher device to the vehicle.
